(19) United States
(12) Patent Application Publication
(10) Pub. No.: US 2020/0047846 A1
(43) Pub. Date: Feb. 13, 2020

(54) A DETACHABLE BICYCLE PEDAL AND DISASSEMBLY AND ASSEMBLY METHOD THEREOF

(71) Applicant: KUNSHAN GENERAL SPORTS CO.LTD, KunShan City, JiangSu Province (CN)

(72) Inventors: Hao ZHU, Jiande City, Hangzhou, Zhejiang (CN); Wenlong LUO, Jiande City, Hangzhou, Zhejiang (CN)

(21) Appl. No.: 16/339,264

(22) PCT Filed: Jul. 14, 2018
(86) PCT No.: PCT/CN2018/095714

§ 371 Date: Apr. 3, 2019

(30) Foreign Application Priority Data
Jun. 21, 2018 (CN) 201820959805.2

(51) Int. Cl. B62M 3/08

(52) U.S. Cl. CPC B62M 3/08

(57) ABSTRACT

A detachable bicycle pedal and disassembly and assembly method thereof. The detachable bicycle pedal has a connecting shaft sleeve, jacket, pedal spindle and pedal. The pedal spindle is connected to the pedal through a bearing. The connecting shaft sleeve is sleeved on the pedal spindle and connected thereto. The jacket is sleeved on the connecting shaft sleeve and connected thereto. The pedal spindle is inserted into the connecting shaft sleeve and in threaded connection with the pedal. The connecting shaft sleeve bears a small force and is not prone to damage. Axial positioning beads control the axial movement of the pedal spindle so that the pedal spindle is not subjected to force during use and the service life is prolonged. The bicycle pedal can be disassembled and assembled by moving the jacket.

### FIELD OF THE INVENTION

The present invention relates to the technical field of vehicles, specifically to a detachable bicycle pedal and a disassembly and assembly method thereof.

### BACKGROUND OF THE INVENTION

As people's living standards improve, field activities are also constantly enriched. Cycling in the wild is one of them. At present, the pedal of a bicycle is connected to a pedal crank by threads. Professional tools are required for assembly and disassembly. When the pedal malfunctions during use, especially in the wild, the maintenance condition is relatively poor, so it is inconvenient to replace the pedal. In addition, a lot of space is wasted in the presence of pedals during manufacture and sale of bicycles. If the pedals are assembled at the time of sale, the transportation efficiency will be improved. These require the pedals to be quickly disassembled and assembled.

Chinese patent No. CN201457668U published on May 12, 2010 discloses a quick disassembly and assembly device for bicycle pedals. The device includes a pedal spindle, a release sleeve, a lock sleeve, a spring and a base, wherein the base is provided with a retainer ring mounting groove and a steel pin mounting groove, a retainer ring is arranged in the retainer ring mounting groove, and a steel pin is arranged in the steel pin mounting groove; the spring, the lock sleeve, the release sleeve and the retainer ring are sleeved on the base successively; the steel pin is located between the lock sleeve and the release sleeve, the pedal spindle is provided with a steel pin fixing groove, and the steel pin is matched with the steel pin fixing groove such that the pedal spindle is movably inserted into the base. The structure uses the steel pin as a fastener. Although the lock sleeve no longer needs to bear a force during the non-operation time, the steel pin is only clamped on the pin fixing groove of the pedal spindle, and the pedal spindle needs to bear a force. As the pedal spindle is operated under the force, the joint between the steel pin and the pin fixing groove is prone to damage, so that the pedal needs to be replaced frequently. In addition, the pedal spindle is connected to a pedal crank through the base, which prolongs the distance between the pedal and the pedal crank. If a small force is applied to the pedal, the joint between the pedal spindle and the pedal crank receives a large force and is thus prone to damage. When the connection distance between the pedal spindle and the pedal crank is lengthened, it is not convenient for the bicycle to turn and stop.

### SUMMARY OF THE INVENTION

In order to solve the above technical problems, the present invention provides a detachable bicycle pedal, wherein the pedal spindle is inserted into the connecting shaft sleeve and is in threaded connection with the pedal, the connecting shaft sleeve bears a small force and is not prone to damage, and the axial positioning beads control the axial movement of the pedal spindle, so that the pedal spindle is not subjected to force during use and its service life is prolonged; and the bicycle pedal can be disassembled and assembled by moving the jacket, so the bicycle pedal is convenient to disassemble and assemble, and the cost of disassembly and assembly is reduced.

In order to achieve the above objective, the technical solution of the present invention is as follows:

A detachable bicycle pedal, comprising a connecting shaft sleeve, a jacket, a pedal spindle and a pedal, wherein the pedal spindle is connected to the pedal through a bearing, the connecting shaft sleeve is sleeved on the pedal spindle and connected thereto, and the jacket is sleeved on the connecting shaft sleeve and connected thereto.

According to the detachable bicycle pedal provided by the present invention, the pedal spindle is inserted into the connecting shaft sleeve and is in threaded connection with the pedal, the connecting shaft sleeve bears a small force and is not prone to damage, and axial positioning beads control the axial movement of the pedal spindle, so that the pedal spindle is not subjected to force during use and its service life is prolonged; and the bicycle pedal can be disassembled and assembled by moving the jacket, so the bicycle pedal is convenient to disassemble and assemble, and the cost of disassembly and assembly is reduced.

Based on the above technical solution, the following improvements can also be made:

As a preferred solution, the connecting shaft sleeve is provided with positioning holes distributed uniformly, and axial positioning beads are arranged in the positioning holes and connected thereto.

As a preferred solution, the pedal spindle is provided with positioning grooves, and the positioning grooves are circumferentially distributed along the outer surface of the pedal spindle.

As a preferred solution, the widths of the positioning grooves are equal to the diameters of the axial positioning beads.

As a preferred solution, the detachable bicycle pedal comprises an elastic component, which is sleeved on the connecting shaft sleeve and connected thereto.

As a preferred solution, the connecting shaft sleeve is provided with a step, and the step is fixedly connected with one end of the elastic component.

As a preferred solution, the inner surface of the jacket is provided with a raised portion, and the raised portion is fixedly connected with the other end of the elastic component.

As a preferred solution, the detachable bicycle pedal comprises a snap ring connected to the connecting shaft sleeve.

As a preferred solution, the connecting shaft sleeve is provided with a clamping groove, and the snap ring is embedded into the clamping slot and connected thereto.

As a preferred solution, a disassembly and assembly method for the detachable bicycle pedal comprises:

disassembling the pedal: the jacket and the pedal are both in a force application state, the axial positioning beads move outward in the diameter direction of the connecting shaft sleeve since the axial positioning beads are not subjected to axial pressure, and the pedal is disassembled; and

assembling the pedal: the jacket is in a force application state, the pedal spindle is inserted into the connecting shaft sleeve, the end face position of the pedal spindle is flush with the end face position of the connecting shaft sleeve, the axial positioning beads enter the positioning grooves, the jacket is in a free state, the jacket moves toward the pedal spindle under the action of the elastic component, the raised portion on the inner surface of the jacket is tightly attached to the axial positioning beads to lock the axial positioning beads, the axial positioning beads cannot move radially, the pedal spindle cannot move axially, and the pedal is thus assembled.

### BRIEF DESCRIPTION OF THE DRAWINGS

FIG. 1 is a front two-side view of a detachable bicycle pedal according to an embodiment of the present invention;

FIG. 2 is a sectional view of the detachable bicycle pedal according to an embodiment of the present invention;

FIG. 3 is a sectional view of the detachable bicycle pedal according to an embodiment of the present invention along A-A in FIG. 2; and

FIG. 4 is a sectional view when the detachable bicycle pedal according to an embodiment of the present invention is disassembled.

Reference signs: 1 connecting shaft sleeve, 2 jacket, 21 elastic component, 3 pedal, 31 pedal spindle, 4 snap ring, 5 axial positioning bead.

### DETAILED DESCRIPTION OF THE EMBODIMENTS

A clear and complete description will be made to the technical solutions in the embodiments of the present invention below. Apparently, the embodiments described are only part of the embodiments of the present invention, not all of them. All other embodiments obtained by a person of ordinary skill in the art based on the embodiments of the present invention without creative efforts shall fall within the protection scope of the present invention.

The preferred embodiments of the present invention will be described in detail below in combination with the accompanying drawings.

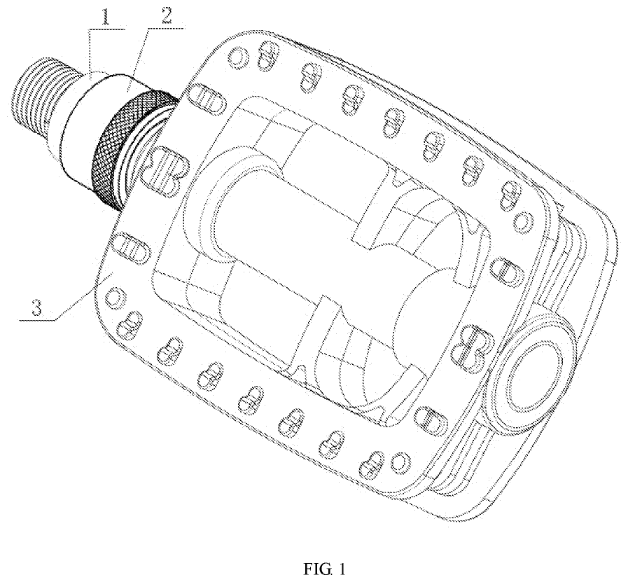

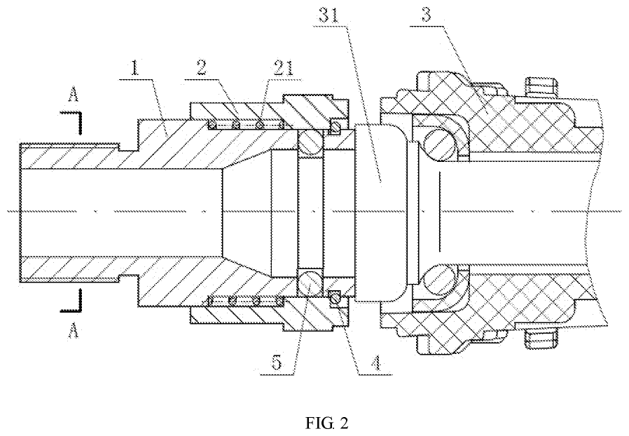

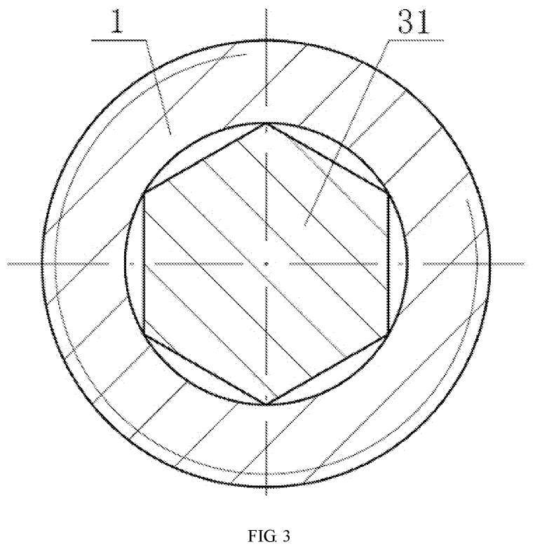

In order to achieve the objective of the present invention, as shown in FIGS. 1 to 4, a detachable bicycle pedal of this embodiment includes a connecting shaft sleeve 1, a jacket 2, a pedal spindle 31 and a pedal 3, wherein the pedal spindle 31 is connected to the pedal 3 through a bearing (not shown), the connecting shaft sleeve 1 is sleeved on the pedal spindle 31 and connected thereto, and the jacket 2 is sleeved on the connecting shaft sleeve 1 and connected thereto.

According to the detachable bicycle pedal provided by the present invention, the pedal spindle 31 is inserted into the connecting shaft sleeve 1 and is in threaded connection with the pedal 3, the connecting shaft sleeve 1 bears a small force and is not prone to damage, and axial positioning beads 5 control the axial movement of the pedal spindle 31, so that the pedal spindle is not subjected to force during use and its service life is prolonged; and the bicycle pedal can be disassembled and assembled by moving the jacket 2, so the bicycle pedal is convenient to disassemble and assemble, and the cost of disassembly and assembly is reduced.

In some embodiments, the connecting shaft sleeve 1 is provided with positioning holes (not shown) distributed uniformly, and axial positioning beads 5 are arranged in the positioning holes (not shown) and connected thereto.

With the above embodiment, the right end of the connecting shaft sleeve 1 is provided with six positioning holes (not shown) distributed uniformly, and the positioning holes (not shown) run through the inner and outer surfaces of the connecting shaft sleeve 1 to facilitate the disassembly or assembly of the detachable bicycle pedal; and the axial positioning beads 5 control the axial movement of the pedal spindle 31, so that the pedal spindle is not subjected to force during use and its service life is prolonged.

In some embodiments, the pedal spindle 31 is provided with positioning grooves (not shown), and the positioning grooves (not shown) are circumferentially distributed along the outer surface of the pedal spindle 31.

With the above embodiment, the positioning grooves (not shown) correspond to and cooperate with the axial positioning beads 5 to facilitate the disassembly or assembly of the detachable bicycle pedal.

In some embodiments, the width of the positioning groove (not shown) is equal to the diameter of the axial positioning bead 5.

With the above embodiment, the positioning grooves (not shown) correspond to and cooperate with the axial positioning beads 5 to facilitate the disassembly or assembly of the detachable bicycle pedal.

In some embodiments, the detachable bicycle pedal includes an elastic component 21, which is sleeved on the connecting shaft sleeve 1 and connected thereto.

According to the above embodiment, the elastic component 21 is preferably a spring, which is simple in structure and convenient to operate, thereby facilitating the disassembly or assembly of the detachable bicycle pedal.

In some embodiments, the connecting shaft sleeve 1 is provided with a step (not shown), and the step (not shown) is fixedly connected with one end of the elastic component 21.

With the above embodiment, the detachable bicycle pedal is simple in structure, easy to operate, and convenient to disassemble or assemble.

In some embodiments, the inner surface of the jacket 2 is provided with a raised portion (not shown), and the raised portion (not shown) is fixedly connected with the other end of the elastic component 21.

With the above embodiment, the inner surface of the raised portion (not shown) is in contact with the low outer surface of the step (not shown) of the connecting shaft sleeve 1, one end of the elastic component 21 is crimped to the joint face of the step (not shown), and the other end of the elastic component 21 is crimped to the raised portion (not shown) on the inner surface of the jacket 2.

In some embodiments, the detachable bicycle pedal includes a snap ring 4 connected to the connecting shaft sleeve 1.

With the above embodiment, the snap ring 4 is connected to the end of the connecting shaft sleeve 1, so that the detachable bicycle pedal is simple in structure, easy to operate, and convenient to disassemble or assemble.

In some embodiments, the connecting shaft sleeve 1 is provided with a clamping groove (not shown), and the snap ring 4 is embedded into the clamping slot (not shown) and connected thereto.

With the above embodiment, the snap ring 4 is embedded into the clamping slot (not shown) and closely attached to the right end face of the jacket 2, so that the detachable bicycle pedal is simple in structure, easy to operate, and convenient to disassemble or assemble.

In some embodiments, a disassembly and assembly method for the detachable bicycle pedal includes:

disassembling the pedal: the jacket 2 and the pedal 3 are both in a force application state, specifically, the jacket 2 moves left to apply force, the pedal 3 moves right to apply force, the axial positioning beads 5 move outward in the diameter direction of the connecting shaft sleeve 1 since the axial positioning beads 5 are not subjected to axial pressure, and the pedal 3 is thus disassembled; and

assembling the pedal: the jacket 2 is in a force application state, specifically, the jacket 2 moves left to apply force, the pedal spindle 31 is inserted into the connecting shaft sleeve 1, the end face position of the pedal spindle 31 is flush with the end face position of the connecting shaft sleeve 1, the axial positioning beads 5 enter the positioning grooves (not shown), the jacket 2 is in a free state, specifically, the jacket 2 does not apply any acting force, the jacket 2 moves toward the pedal spindle 31 under the action of the elastic component 21, the raised portion (not shown) on the inner surface of the jacket 2 is tightly attached to the axial positioning beads 5 to lock the axial positioning beads 5, the axial positioning beads 5 cannot move radially, the pedal spindle 31 cannot move axially, and the pedal 3 is thus assembled.

With the above embodiment, the pedal spindle 31 is inserted into the connecting shaft sleeve 1 and is in threaded connection with the pedal 3, the connecting shaft sleeve 1 bears a small force and is not prone to damage, and the axial positioning beads 5 control the axial movement of the pedal spindle 31, so that the pedal spindle is not subjected to force during use and its service life is prolonged; and the bicycle pedal can be disassembled and assembled by moving the jacket 2, so the bicycle pedal is convenient to disassemble and assemble, and the cost of disassembly and assembly is reduced.

A detachable bicycle pedal includes a pedal 3 and a pedal crank (not shown), the pedal 3 is rotatably connected to a pedal spindle 31, and the right side of the pedal spindle 31 is rotatably connected to the pedal 3 through a bearing. The cross section of the left end of the pedal spindle 31 is of a regular polygon, and the regular polygon is preferably a regular hexagon. The pedal spindle 31 is sleeved with a connecting shaft sleeve 1, the outer surface of the left end of the connecting shaft sleeve 1 is provided with threads, and the connecting shaft sleeve 1 is in threaded connection with the pedal crank. The inner hole of the threaded end of the connecting shaft sleeve 1 is of a regular polygon, the inner surface of the left end of the connecting shaft sleeve 1 is of a regular polygon, and the regular polygons are the same as the regular polygon of the cross section of the left end of the pedal spindle 31 in shape and size. The right end of the connecting shaft sleeve 1 is provided with six positioning holes distributed uniformly, the positioning holes run through the inner and outer surfaces of the connecting shaft sleeve 1, the positioning holes are connected with axial positioning beads 5, and the axial positioning beads 5 are balls or roller pins, preferably balls. The pedal spindle 31 is provided with positioning grooves. The widths of the positioning grooves (not shown) are equal to the diameters of the axial positioning beads 5, and the positioning grooves (not shown) are arranged around the outer surface of the pedal spindle 31. When the pedal spindle 31 is inserted into the connecting shaft sleeve 1, the left end face of the pedal spindle 31 is flush with the left end face of the connecting shaft sleeve 1, and the axial positioning beads 5 just can enter the positioning grooves (not shown). The connecting shaft sleeve 1 is sleeved with an elastic component 21, the right end of the connecting shaft sleeve 1 is provided with a step (not shown), the elastic component 21 is sleeved on the low outer surface of the step (not shown), the jacket 2 is sleeved outside the connecting shaft sleeve 1, the elastic component 21 is crimped to the jacket 2, the inner surface of the jacket 2 is provided with a raised portion, the inner surface of the raised portion is in contact with the low outer surface of the step of the connecting shaft sleeve 1, one end of the elastic component 21 is crimped to the joint face of the step of the connecting shaft sleeve 1, and the other end of the elastic component 21 is crimped to the raised portion of the inner surface of the jacket 2. The end of the connecting shaft sleeve 1 is connected with a snap ring 4, the connecting shaft sleeve 1 is provided with a clamping groove on the outer surface of the connecting shaft sleeve close to the right end face, the snap ring 4 is embedded into the clamping slot, and the snap ring 4 is closely attached to the right end face of the jacket 2.

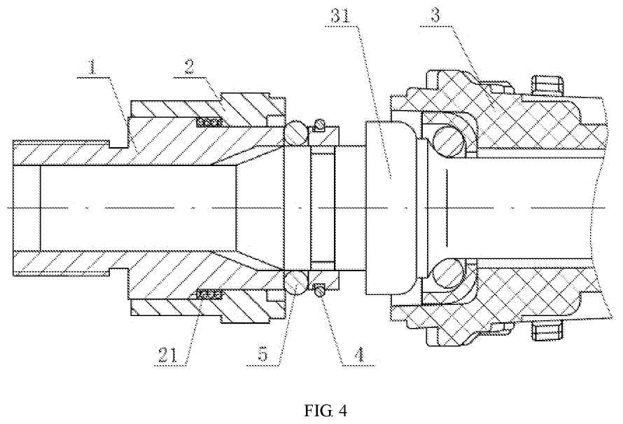

When the pedal 3 is disassembled, the jacket 2 is moved to the left by hand to overcome the elastic force of the spring 21. The pedal 3 is pulled to the right, the axial positioning beads 5 move outward in the diameter direction of the connecting shaft sleeve 1 since the axial positioning beads 5 are not subjected to axial pressure, as shown in FIG. 4, and the pedal 3 can be smoothly disassembled. A new pedal 3 is replaced, the jacket 2 is moved to the left by hand, and the pedal spindle 31 of the new pedal 3 is inserted into the connecting shaft sleeve 1. When the end face position of the pedal spindle 31 is flush with the end face position of the connecting shaft sleeve 1, the axial positioning beads 5 fall into the positioning grooves. The jacket 2 is released. Due to the action of the elastic component 21, the jacket 2 moves to the right. The raised portion on the inner surface of the jacket 2 is tightly attached to the axial positioning beads 5 to lock the axial positioning beads 5, the axial positioning beads 5 cannot move radially, the pedal spindle 31 cannot move axially, and the pedal 3 is thus assembled.

Described above are merely preferred embodiments of the present invention. It should be pointed out that a person of ordinary skill in the art may further make variations and improvements without departing from the conception of the present invention, and these all fall within the protection scope of the present invention.

1. A detachable bicycle pedal, comprising a connecting shaft sleeve, a jacket, a pedal spindle and a pedal, wherein the pedal spindle is connected to the pedal through a bearing, the connecting shaft sleeve is sleeved on the pedal spindle and connected thereto, and the jacket is sleeved on the connecting shaft sleeve and connected thereto.

2. The detachable bicycle pedal according to claim 1, wherein the connecting shaft sleeve is provided with positioning holes distributed uniformly, and axial positioning beads are arranged in the positioning holes and connected thereto.

3. The detachable bicycle pedal according to claim 2, wherein the pedal spindle is provided with positioning grooves, and the positioning grooves are circumferentially distributed along the outer surface of the pedal spindle.

4. The detachable bicycle pedal according to claim 3, wherein the widths of the positioning grooves are equal to the diameters of the axial positioning beads.

5. The detachable bicycle pedal according to claim 4, wherein the detachable bicycle pedal comprises an elastic component, which is sleeved on the connecting shaft sleeve and connected thereto.

6. The detachable bicycle pedal according to claim 5, wherein the connecting shaft sleeve is provided with a step, and the step is fixedly connected with one end of the elastic component.

7. The detachable bicycle pedal according to claim 6, wherein the inner surface of the jacket is provided with a raised portion, and the raised portion is fixedly connected with the other end of the elastic component.

8. The detachable bicycle pedal according to claim 7, wherein the detachable bicycle pedal comprises a snap ring connected to the connecting shaft sleeve.

9. The detachable bicycle pedal according to claim 8, wherein the connecting shaft sleeve is provided with a clamping groove, and the snap ring is embedded into the clamping groove and connected thereto.

10. A disassembly and assembly method for the detachable bicycle pedal, comprising:
disassembling the pedal: the jacket and the pedal are both in a force application state, the axial positioning beads move outward in the diameter direction of the connecting shaft sleeve since the axial positioning beads are not subjected to axial pressure, and the pedal is disassembled; and
assembling the pedal: the jacket is in a force application state, the pedal spindle is inserted into the connecting shaft sleeve, the end face position of the pedal spindle is flush with the end face position of the connecting shaft sleeve, the axial positioning beads enter the positioning grooves, the jacket is in a free state, the jacket moves toward the pedal spindle under the action of the elastic component, the raised portion on the inner surface of the jacket is tightly attached to the axial positioning beads to lock the axial positioning beads, the axial positioning beads cannot move radially, the pedal spindle cannot move axially, and the pedal is thus assembled.
